(19) United States
(12) Patent Application Publication
(10) Pub. No.: US 2009/0217079 A1
(43) Pub. Date: Aug. 27, 2009

(54) METHOD AND APPARATUS FOR REPAIRING MULTI-CONTROLLER SYSTEM

(75) Inventors: Renwei LIU, Shenzhen (CN); Hua CHEN, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: Huawei Technologies Co., Ltd., Shenzhen (CN)

(21) Appl. No.: 12/352,400

(22) Filed: Jan. 12, 2009

(30) Foreign Application Priority Data
Feb. 22, 2008 (CN) 200810007277.1

(51) Int. Cl. G06F 11/16

(52) U.S. Cl. 714/4; 714/E11.054

(57) ABSTRACT

A method and apparatus for repairing a multi-controller system is provided. The method includes: starting network boot, by a controller whose system boot fails, to download repair files from a controller whose operation is normal; and repairing, by the controller whose system boot fails, its own system, based on the repair files. The apparatus includes at least two controllers, and a network boot unit coupled to the at least two controllers, configured to start network boot by a controller whose system boot fails. Each controller includes a detection unit, a local boot unit, a repair file downloading unit, and a repairing unit. According to embodiments of the invention, after system boot fails to any controller, system repair may be performed automatically by downloading system files from another controller through network boot.

### CROSS-REFERENCE TO RELATED APPLICATIONS

This application claims priority to Chinese Patent Application No. 200810007277.1, filed Feb. 22, 2008, which is hereby incorporated by reference in its entirety.

### FIELD OF THE INVENTION

The invention relates to a control system having a multi-controller structure, and more particularly, to a method and apparatus for repairing a multi-controller system.

### BACKGROUND

In a control system, a dual-controller or multi-controller structure is typically employed to improve the system reliability. A network connection is often utilized among the multiple controllers for communication with each other. When the system is running, the contents buffered in a controller are mirrored completely to another controller, so as to provide redundant performance for each other.

FIG. 1 illustrates the configuration of two controllers, each controller maintaining two caches. When the system operates normally, the data in cache 1 of controller 1 is mirrored to cache 1 of controller 2, and the data in cache 2 of controller 2 is mirrored to cache 2 of controller 1. Such a multi-controller configuration may improve the reliability of the control system, and keep redundancy of the controllers by reconfiguring the caches with data buffered in the caches of the redundant controllers.

In the implementation of the invention, the inventors have found through research that the network connection for the related art dual-controller or multi-controller is used only for related data synchronization and redundancy design. When a failure occurs in the system file of a controller, the controller cannot be recovered automatically. Rather, it can be recovered only by reinstalling Operating System (OS) manually, which affects the reliability of the system.

### SUMMARY

In one aspect, an embodiment of the invention provides a method for repairing a multi-controller system. According to the method, automatic system repair of a controller may be implemented and the control system may run under multiple controllers always.

A method for repairing a multi-controller system includes: starting network boot, by a controller whose system boot fails, to download repair files from a controller whose operation is normal; and repairing, by the controller whose system boot fails, its own system, based on the repair files

In another aspect, an embodiment of the invention provides an apparatus for repairing a multi-controller system. According to such an apparatus, the system of a controller may be repaired automatically and the control system may always run under multiple controllers.

An apparatus for repairing a multi-controller system includes: at least two controllers; and a network boot unit coupled to the at least two controllers, configured to start network boot for a controller whose system boot fails. Each controller includes a detection unit, a local boot unit, a repair file downloading unit, and a repairing unit.

The detection unit is configured to detect whether the local boot unit of the controller has a successful system boot, and to start the network boot unit if unsuccessful.

The local boot unit is configured to start local system boot for the controller, so as to load an application for execution.

The repair file downloading unit is configured to download, for a controller whose system boot fails, repair files from a controller whose operation is normal.

The repairing unit is configured to repair the controller's own system based on the repair files.

### BRIEF DESCRIPTION OF THE DRAWINGS

FIG. 1 illustrates a schematic diagram of providing system redundancy with multiple controllers;

FIG. 2 is a flow chart showing a method for repairing a multi-controller system according to an embodiment of the present invention;

FIG. 3 illustrates a schematic diagram of the PXE technique used according to an embodiment of the invention;

FIG. 4 shows the configuration of the control block for a dual-controller according to an embodiment of the invention;

FIG. 5 is a flow chart of configuring for network boot in the controller according to an embodiment of the invention;

FIG. 6 is a flow chart of configuring a TFTP server according to the PXE technique according to an embodiment of the invention;

FIG. 7 is a flow chart of configuring a DHCP server according to the PXE technique according to an embodiment of the invention;

FIG. 8 is a block diagram showing an apparatus for repairing a multi-controller system according to an embodiment of the invention; and

FIG. 9 is a block diagram showing an apparatus for repairing a multi-controller system according to an embodiment of the invention.

### DETAILED DESCRIPTION

To implement automatic system repair of the controller, a method and apparatus for repairing a multi-controller system is provided in various embodiments of the invention. Accordingly, the control system may operate under multiple controllers always, and thus the reliability of the control system is improved. Detailed description will be made below with reference to embodiments.

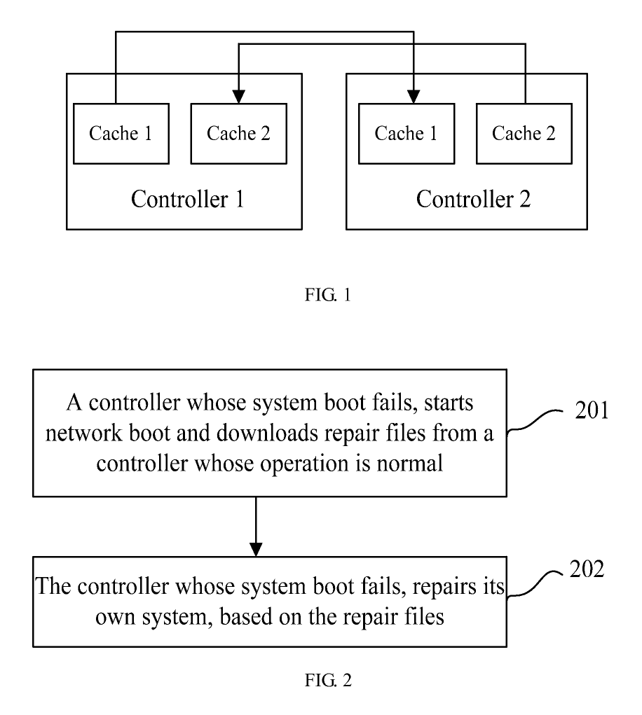

FIG. 2 illustrates a method for repairing a multi-controller system according to an embodiment of the present invention

In step 201, a controller whose system boot fails, starts network boot, so as to download repair files from a controller whose operation is normal.

The network boot refers to starting system boot according to the PXE technique in such a manner that the client downloads system boot programs from the server via the network.

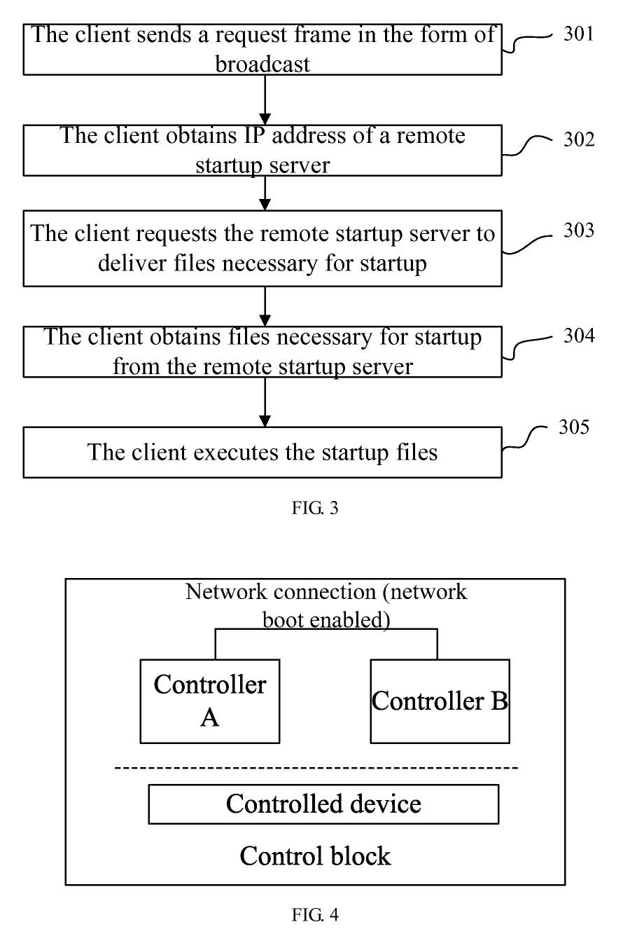

The principle of the PXE technique is shown in FIG. 3.

At 301, the client sends a request frame in the form of broadcast. After the client starts up, the self-startup chip on its network card sends a request frame in the form of broadcast, for example a FIND frame, which carries the ID number of the network card.

At 302, the client obtains an IP address of the remote startup server. On receipt of the FIND frame broadcast from the client, the remote startup server responds with a FOUND frame based on the network card ID carried in the FIND frame, the FOUND frame containing the network card ID of the remote startup server.

At 303, the client requests the remote startup server to deliver files necessary for startup. On receipt of the FOUND frame returned from the remote startup server, the client responds with a frame to request the remote startup server to deliver files necessary for startup.

At 304, the client obtains the files necessary for startup from the remote startup server. On receipt of the request frame for delivering files necessary for startup, the remote startup server looks up the client records in its remote startup database for the corresponding startup block and deliver the files necessary for startup to the client.

At 305, the client executes the files necessary for startup. Upon receipt of the complete files necessary for startup, the client begins to execute startup program in the files necessary for startup, and turns the execution point to the entry of the startup block to start the client.

For different operation systems, there are different booting ways, of course.

In this embodiment, to enable network boot, in hardware, each controller is equipped with a network card having support for PXE, for example Intel's ESB2 integrated network card; in software, there is a need to set a network boot startup option, for example, the hard disk is set as the first startup option and the ESB2 integrated network card is set as the second startup option in the system boot program CMOS.

The hard disk is not limited to RAIDI disk array. Rather, it may be SCSI hard disk, RAIDO/3/5 array, single IDE hard disk, tape drive, tape library, CD-ROM, CF card, flash memory or other storage media.

In the case of a dual-controller, a network card having support for PXE is provided between the two controllers of the control system, as shown in FIG. 4. After the control system is powered on, the system boot program is started from each controller. If the OS is booted successfully, an application is loaded into the controller and executed. If the OS is booted unsuccessfully, the controller whose system boot fails, starts network boot and download repair files from a controller whose operation is normal. For network boot, each of the two controllers may act as a server or a client.

The OS is not limited to a Linux series OS, and may be a Windows series OS or a UNIX series OS or other OS.

In order to perform network boot, each of the two controllers may be configured as shown in FIG. 5.

At 501, a kernel file and an initramfs (initial RAM file system) file are compiled.

At 502, a Trivial File Transfer Protocol (TFTP) server is configured according to the PXE technique.

At 503, a Dynamic Host Configuration Protocol (DHCP) server is configured according to the PXE technique.

At 504, a network boot startup option is set.

Taking a Linux OS as an example, the steps are as follows.

At step 501, the kernel file bzImage and initial RAM file system file initramfs are compiled.

This step is a preparatory step. In this embodiment, the boot system is a Linux system based on an unattended project. By using commands carried in a system which is loaded by a controller acting as the client, the system boot program may be downloaded from the controller which acts as the server.

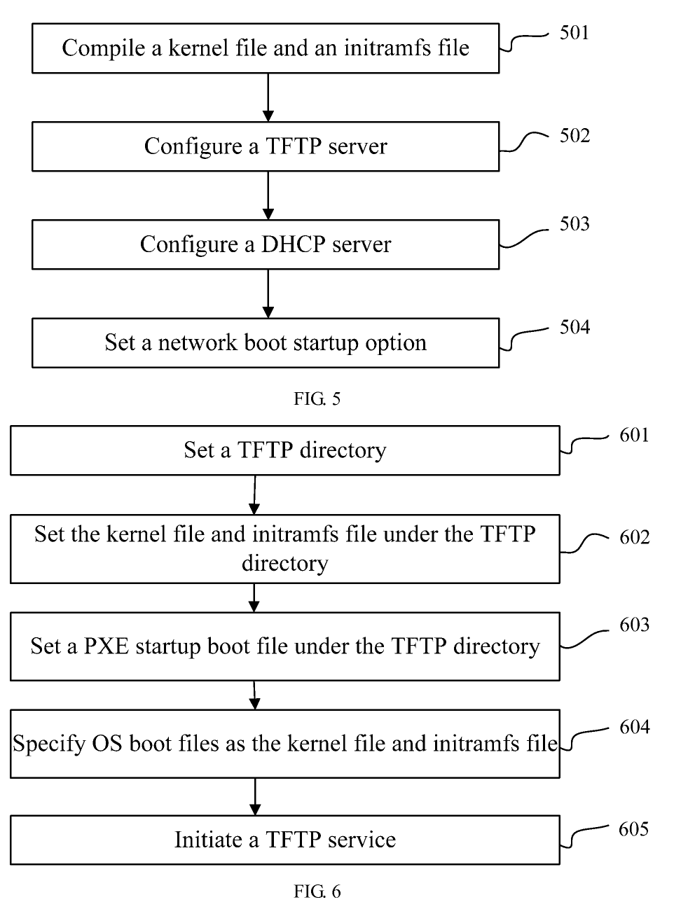

At step 502, the TFTP server is configured according to the PXE technique, the steps of which are shown in FIG. 6.

At 601, the TFTP directory is set as /tftpboot/.

At 602, the kernel file bzImage and the initial RAM file system file initramfs are configured under the TFTP directory /tftpboot/.

At 603, the PXE startup boot file pxelinux.0 is configured under the directory /tftpboot/.

At 604, the /tftpboot/pxelinux.cfg/default file is configured, and the OS files to be booted at the client are specified as bzImage and initramfs.

At 605, the TFTP service is initiated.

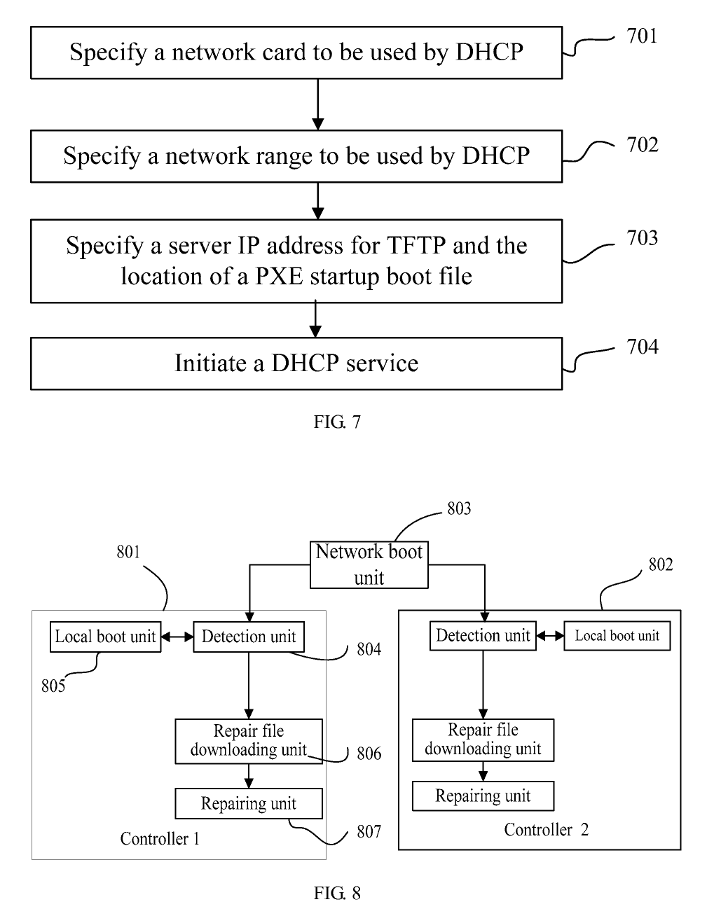

At step 503, the DHCP server is configured according to the PXE technique, the steps of which are shown in FIG. 7.

At 701, /etc/sysconfig/dhcpd is configured and the network card to be used by the DHCP is specified.

At 702, /etc/dhcpd.conf is configured and the network range is specified for the DHCP.

The DHCP configuration is of great importance, which decides whether a correct boot is made according to the PXE technique. For example, the network range is specified for the DHCP, with the start address as 192.168.0.2, the end address as 192.168.0.80 and the subnet mask as 255.255.255.0.

At 703, the IP address is specified for the TFTP server and the location of the PXE startup boot file is specified.

For example, the IP address 192.168.0.1 is specified for the TFTP server, with the subnet mask as 255.255.255.0 and the gateway as 192.168.0.1.

In this embodiment, the specified location of the PXE startup boot file is configured under the directory /tftpboot/.

At 704, the DHCP service is initiated.

According to the above configurations, when the system files of a controller are damaged, the controller whose system boot fails, will act as a client, and uses the PXE technique to obtain the necessary system repair package from a controller whose operation is normal. At this time, the controller whose operation is normal acts as the server of the network boot.

After the controller whose system boot fails obtains the IP address of the controller whose operation is normal, it obtains the startup boot file pxeliunx.0, the configuration file default, the kernel file bzImage and initial RAM file system file initramfs, and downloads the system repair package from the controller whose operation is normal to the local controller via FTP.

At step 202, the controller whose system boot fails repairs its own system according to the repair file.

If the repair is successful, the system is rebooted; if the repair is unsuccessful, an application is downloaded from the controller whose operation is normal, and then loaded for execution.

According to embodiments of the invention, network boot function is added to the network connection between multiple controllers so that any of the controllers may be booted through network boot even if its system software is damaged. Then, the controller downloads the system file from another controller and is repaired. Even if the repair is unsuccessful, the controller may download an application from another controller and run the application. In this way, the system may operate under multiple controllers always, which greatly improves the system reliability.

FIG. 8 illustrates a block diagram of an apparatus for repairing a multi-controller system according to an embodiment of the invention, including: at least two controllers (801, 802); and a network boot unit 803 coupled to the at least two controllers, configured to start network boot for a controller of the at least two controllers whose system boot fails.

Each controller includes a detection unit 804, a local boot unit 805, a repair file downloading unit 806, and a repairing unit 807.

The local boot unit 805 is configured to start local system boot for the controller, so as to load an application for execution.

The detection unit 804 is configured to detect whether the local boot unit of the controller has booted its system successfully, and to start the network boot unit 803 if unsuccessful.

The repair file downloading unit 806 is configured to download, for a controller whose system boot fails, repair files from a controller whose operation is normal when the network boot unit is started. The repairing unit 807 is configured to repair the controller's own system based on the repair files downloaded by the repair file downloading unit.

In order to implement network boot function over the network connection between the multiple controllers, each controller needs to be configured as follows.

A network startup boot option is set. For example, in CMOS, the hard disk is set as the first startup option and the PEX-enabled network card is set as the second startup option.

The kernel file and the initramfs file are compiled.

The TFTP server is configured, for example: The TFTP directory is configured; the kernel file and the initramfs file are configured under the TFTP directory; the PXE startup boot file is configured under the TFTP directory; the OS boot files is specified as the kernel file and the initramfs file; and the TFTP service is initiated.

The DHCP server is configured, for example: The network card to be used by the DHCP is specified; the network range is specified for the DHCP; the IP address is specified for the TFTP server and the location of the PXE startup boot file is specified; and the DHCP service is initiated.

In the repair file downloading unit 806, the controller whose system boot fails, acting as the client, obtains the IP address of the controller whose operation is normal (acting as the server), obtains the startup boot file, the configuration file, the kernel file and the initramfs file, and then downloads the system repair package via FTP from the controller which acts as the server to the controller whose system boot fails.

According to the apparatus for repairing a multi-controller system according to an embodiment of the invention, the method for repairing a multi-controller system according to embodiment 1 may be performed. The network boot unit is connected between the dual controllers or multiple controllers. A controller, whose system boot fails, may enable network boot, download repair programs from a controller whose operation is normal, and repair its own system. This ensures that the control system may operate under multiple controllers always, which greatly improves the system reliability and leads to cost savings, without additional storage media for system backup and recovery.

Embodiments of the invention may be applied to various control systems, and system recovery may be performed for the controlled devices such as storage systems or operation systems.

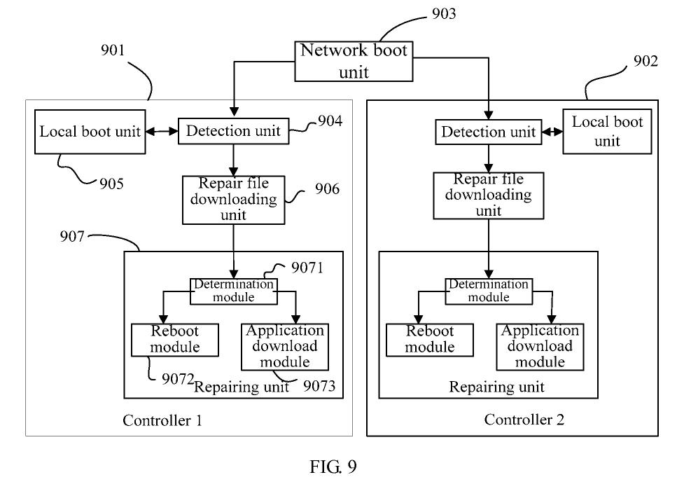

FIG. 9 illustrates a block diagram of an apparatus for repairing a multi-controller system according to an embodiment of the invention, including: at least two controllers (901, 902); and a network boot unit 903 coupled to the at least two controllers, configured to start network boot for a controller whose system boot fails.

Each controller includes a detection unit 904, a local boot unit 905, a repair file downloading unit 906, and a repairing unit 907.

The detection unit 904 is configured to detect whether the local boot unit of the controller has booted the system successfully, and to start the network boot unit if unsuccessful. The local boot unit 905 is configured to start local system boot by the controller, so as to load an application for execution. The repair file downloading unit 906 is configured to download, for a controller whose system boot fails, repair files from a controller whose operation is normal. The repairing unit 907 is configured to repair the controller's own system based on the repair files.

The repairing unit further includes a determination module 9071, a reboot module 9072, and an application downloading module 9073.

The determination module 9071 is configured to determine whether the controller has successfully repaired its own system, to start the reboot module 9072 if the repair is successful, and to start the application downloading module 9073 if the repair is unsuccessful. The reboot module 9072 is configured to reboot the system. The application downloading module 9073 is configured to download an application from a controller whose operation is normal, and load the application for execution.

According to the embodiment of the invention, when system boot failure occurs to a controller, the network boot unit starts network boot. The repair file downloading unit downloads repair files from a controller whose operation is normal, to the controller whose system boot fails. The repairing unit performs system repair in the controller whose system boot fails. In the repairing unit, the determination module determines whether the controller has successfully repaired its own system. If the repair is successful, the reboot module is started and the control system enters into the normal state. If the repair is unsuccessful, the application downloading module is started, and an application is downloaded from the controller whose operation is normal and loaded for execution. In this way, the system according to this embodiment may always operate under multiple controllers, which greatly improves the system reliability.

Many other embodiments of the invention are possible. Within the scope of the embodiments of the invention, those skilled in the art may make various changes and modifications to the embodiments. The embodiments of the invention may be applied to different control systems. These changes and modifications are within the scope of the appended claims.

What is claimed is:

1. A method for repairing a multi-controller system, comprising:
starting network boot, by a controller whose system boot fails, to download repair files from a controller whose operation is normal; and
repairing, by the controller whose system boot fails, its own system, based on the repair files.

2. The method for repairing a multi-controller system according to claim 1, wherein the controller whose system boot fails repairs its own system, and wherein the system is rebooted if the repair is successful, and an application is downloaded from the controller whose operation is normal and loaded for execution if the repair is unsuccessful.

3. The method for repairing a multi-controller system according to claim 1, further comprising the following steps related to the controller whose system boot fails starts network boot:
compiling a kernel file and an initial RAM file system(initramfs) file;
configuring a Trivial File Transfer Protocol (TFTP) server and a Dynamic Host Configuration Protocol (DHCP) server according to a Preboot Execution Environment (PXE), respectively; and
setting a network boot startup option.

4. The method for repairing a multi-controller system according to claim 3, wherein configuring the TFTP server according to the PXE comprising:
setting a TFTP directory;
configuring the kernel file and initramfs file under the TFTP directory;
configuring a PXE startup boot file under the TFTP directory;
specifying Operating System (OS) boot files as the kernel file and initramfs file; and
initiating a TFTP service.

5. The method for repairing a multi-controller system according to claim 3, wherein the configuring the DHCP server according to the PXE comprising:
specifying a network card and a network range to be used by the DHCP;
specifying a server IP address for the TFTP;
specifying the location of a PXE startup boot file; and
initiating a DHCP service.

6. An apparatus for repairing a multi-controller system, comprising:
at least two controllers; and
a network boot unit coupled to the at least two controllers, configured to start network boot for a controller of the at least two controllers whose system boot fails;
each controller comprising a detection unit, a local boot unit, a repair file downloading unit, and a repairing unit, the local boot unit is configured to start local system boot for the controller, so as to load an application for execution;
the detection unit is configured to detect whether the local boot unit of the controller has a successful system boot, and to start the network boot unit if unsuccessful;
the repair file downloading unit is configured to download, for the controller whose system boot fails, repair files from a controller whose operation is normal when the network boot unit is started; and
the repairing unit is configured to repair the controller's own system based on the repair files downloaded by the repair file downloading unit.

7. The apparatus for repairing a multi-controller system according to claim 6, wherein the repairing unit further comprises a determination module, a reboot module, and an application downloading module;
the determination module is configured to determine whether the controller has successfully repaired its own system, to start the reboot module if the repair is successful, and to start the application downloading module if the repair is unsuccessful;
the reboot module is configured to reboot the system; and the application downloading module is configured to download an application from a controller whose operation is normal, and to load the application for execution.
